(19) United States
(12) Patent Application Publication
(10) Pub. No.: US 2023/0324073 A1
(43) Pub. Date: Oct. 12, 2023

(54) ELECTRICAL ENCLOSURE FOR HVAC SYSTEM

(71) Applicant: Johnson Controls Tyco IP Holdings LLP, Milwaukee, WI (US)

(72) Inventors: Scott Victor Slothower, Dillsburg, PA (US); Michael Scott Todd, Jacobus, PA (US); Ajit Wasant Kane, York, PA (US); Kanishk Dubey, York, PA (US); Zhiqiao Wu, York, PA (US); Jonathan Eugene Kunkle, Hanover, PA (US); Karl Richard Barley, York, PA (US)

(21) Appl. No.: 18/024,234

(22) PCT Filed: Aug. 31, 2021
(86) PCT No.: PCT/US2021/048527

§ 371 Date: Mar. 1, 2023

Related U.S. Application Data
(60) Provisional application No. 63/073,310, filed on Sep. 1, 2020.

(51) Int. Cl. F24F 11/86; F24F 13/20; F25B 31/00; F25B 49/02

(52) U.S. Cl. CPC F24F 11/86; F24F 13/20; F25B 31/00; F25B 49/02; F24F 2013/202

(57) ABSTRACT

A heating, ventilation, and/or air conditioning (HVAC) system includes an electrical enclosure having a compressor variable speed drive (VSD) and a condenser fan VSD disposed within the electrical enclosure. The compressor VSD is configured to control operation of a compressor motor of the HVAC system, and the condenser fan VSD is configured to control operation of a condenser fan motor of the HVAC system.

### CROSS REFERENCE TO RELATED APPLICATION

This application claims priority from and the benefit of U.S. Provisional Patent Application Ser. No. 63/073,310, entitled “ELECTRICAL ENCLOSURE FOR HVAC SYSTEM,” filed Sep. 1, 2020, which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Chiller systems, or vapor compression systems, utilize a working fluid (e.g., a refrigerant) that changes phases between vapor, liquid, and combinations thereof, in response to exposure to different temperatures and pressures within components of the chiller system. A chiller system may place the working fluid in a heat exchange relationship with a conditioning fluid (e.g., water) and may deliver the conditioning fluid to conditioning equipment and/or a conditioned environment serviced by the chiller system. In such applications, the conditioning fluid may be passed through downstream equipment, such as air handlers, to condition other fluids, such as air in a building. The chiller system may also include multiple enclosures to house various components. For example, various electrical components may be disposed within respective electrical enclosures. Unfortunately, manufacturing separate electrical enclosures for such components may increase cost and/or complexity of manufacturing the chiller system. For instance, additional features and components, such as cooling systems, power conditioning components, motor drives, wirings, couplings, connectors, and so forth, may be manufactured and implemented in order to enable the operation of the components, and the additional features may be disposed within separate electrical enclosures.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a heating, ventilation, and/or air conditioning (HVAC) system includes an electrical enclosure having a compressor variable speed drive (VSD) and a condenser fan VSD disposed within the electrical enclosure. The compressor VSD is configured to control operation of a compressor motor of the HVAC system, and the condenser fan VSD is configured to control operation of a condenser fan motor of the HVAC system.

In an embodiment, a heating, ventilation, and/or air conditioning (HVAC) system includes an electrical enclosure configured to enclose electrical components of the HVAC system to shield the electrical components from an ambient environment, a compressor variable speed drive (VSD) disposed within the electrical enclosure, a condenser fan VSD disposed within the electrical enclosure, and a cooling system disposed within the electrical enclosure. The compressor VSD is configured to operate a compressor motor of the HVAC system, the condenser fan VSD is configured to operate a condenser fan motor of the HVAC system, and the cooling system is configured to place a cooling fluid in a heat exchange relationship with the compressor VSD and the condenser fan VSD and to reject heat from the compressor VSD and the condenser fan VSD.

In an embodiment, a heating, ventilation, and/or air conditioning (HVAC) system includes a refrigerant circuit, a compressor disposed along the refrigerant circuit and configured to pressurize a refrigerant flowing through the refrigerant circuit, a condenser disposed along the refrigerant circuit, a main drive line electrical enclosure, a compressor variable speed drive (VSD) disposed within the main drive line electrical enclosure, and a condenser fan VSD disposed within the main drive line electrical enclosure. The condenser includes a condenser fan configured to force an air flow across the condenser to cool the refrigerant flowing through the refrigerant circuit, the compressor and the condenser are positioned external to the main drive line electrical enclosure, the compressor VSD is configured to operate a compressor motor to drive operation of the compressor to pressurize the refrigerant, and the condenser fan VSD is configured to operate a condenser fan motor to drive operation of the condenser fan to force the air flow across the condenser.

### DRAWINGS

Various aspects of this disclosure may be better understood upon reading the following detailed description and upon reference to the drawings in which:

FIG. 1 is a perspective view of a building that may utilize an embodiment of a heating, ventilation, and/or air conditioning (HVAC) system in a commercial setting, in accordance with an aspect of the present disclosure;

FIG. 2 is a schematic of an embodiment of a vapor compression system, in accordance with an aspect of the present disclosure; and

FIG. 3 is a schematic of an embodiment of an HVAC system with a main drive line electrical enclosure, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure relate to a heating, ventilation, and/or air conditioning (HVAC) system, such as a chiller system. The HVAC system may include a vapor compression system through which a refrigerant is directed in order to cool and/or heat a conditioning fluid. As an example, the vapor compression system may include a compressor configured to pressurize the refrigerant and to direct the pressurized refrigerant to a condenser configured to cool the refrigerant. An evaporator of the vapor compression system may receive the cooled refrigerant and may place the cooled refrigerant in a heat exchange relationship with the conditioning fluid to absorb heat or thermal energy from the conditioning fluid, thereby cooling the conditioning fluid. The cooled conditioning fluid may then be delivered to a space serviced by the HVAC system to cool and condition the space.

In some embodiments, the HVAC system may include multiple electrical enclosures configured to accommodate various electrical components and shield the electrical components from an ambient or external environment. As described herein, an electrical enclosure refers to a physical housing suitable for (e.g., configured to, designed to) enclosing electrical components, such as a physical housing having a certain moisture rating, being manufactured from a particular type or class of material, enabling an amount of heat transfer with the ambient environment, and so forth. For example, the HVAC system may include a first electrical enclosure in which an electrical subsystem configured to operate the compressor may be disposed. The HVAC system may also include a second electrical enclosure in which an electrical subsystem configured to operate the condenser (e.g., operate a fan that directs an air flow across the condenser to cool the refrigerant) may be disposed.

Unfortunately, utilizing separate electrical enclosures for housing respective electrical components or subsystems may increase cost and/or complexity of manufacturing the HVAC system. As an example, a respective cooling system may be included in each electrical enclosure in order to cool the respective electrical components disposed within one of the electrical enclosures during operation. As another example, complex wiring, power conditioning components, motor drives, and/or couplings may be used to couple the electrical components in different enclosures to one another, to a power source (e.g., a respective power source), to other components of the HVAC system, and so forth, in order to enable desired operation of the HVAC system. As a further example, manufacture of or purchase of separate electrical enclosures may increase a complexity or cost associated with manufacture of the HVAC system. Indeed, different embodiments of electrical enclosures may be used for different embodiments or types of electrical subsystems disposed therein, and/or specific electrical enclosure embodiments may be incorporated for each different HVAC system. Thus, configurability of various HVAC system embodiments may be complicated, and practicality of manufacturing large quantities of the same electrical subsystem embodiment may be reduced. Further still, the separate electrical enclosures may occupy a large overall amount of space or footprint within the HVAC system, and excessive energy consumption may result from operation of separate electrical subsystems (e.g., increased power consumption by respective cooling systems of the various electrical enclosures).

Thus, it is presently recognized that reducing the number of electrical enclosures of the HVAC system may improve the manufacture and/or operation of the HVAC system. Accordingly, embodiments of the present disclosure are directed to an electrical enclosure configured to house multiple components, such as multiple electrical subsystems of the HVAC system. For example, a single electrical enclosure may house a first electrical subsystem configured to operate the compressor and a second electrical subsystem configured to operate the condenser of the HVAC system. The single electrical enclosure may reduce cost and/or complexity associated with the manufacture and/or operation of the HVAC system. Moreover, a single cooling system configured to cool multiple electrical subsystems may be disposed within the electrical enclosure, and the single electrical enclosure may occupy a smaller footprint relative to a combined or total footprint occupied by multiple electrical enclosures in traditional HVAC systems.

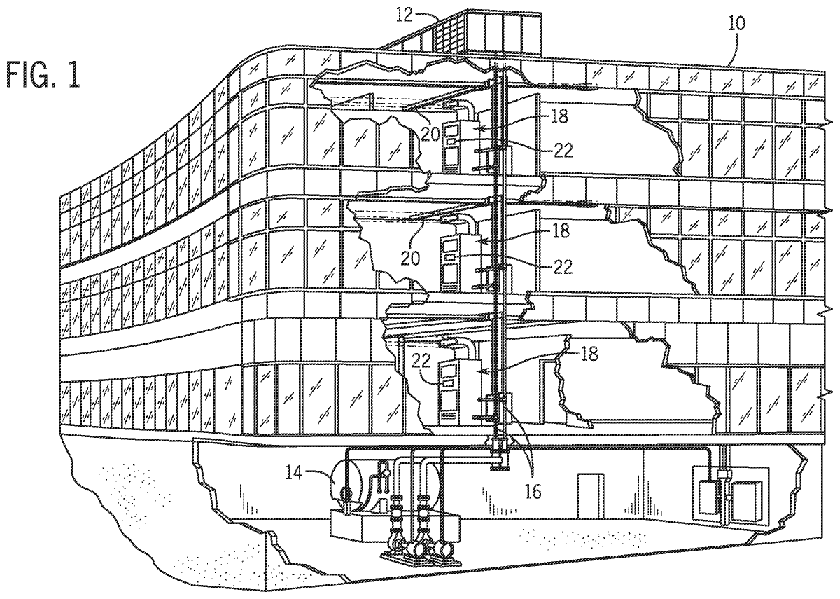

Turning now to the drawings, FIG. 1 is a perspective view of an embodiment of an application for a heating, ventilation, and air conditioning (HVAC) system. Such systems, in general, may be applied in a range of settings, both within the HVAC field and outside of that field. The HVAC systems may provide cooling to data centers, electrical devices, freezers, coolers, or other environments through vapor compression refrigeration, absorption refrigeration, or thermoelectric cooling. In presently contemplated applications, however, HVAC systems may be used in residential, commercial, light industrial, industrial, and in any other application for heating or cooling a volume or enclosure, such as a residence, building, structure, and so forth. Moreover, the HVAC systems may be used in industrial applications, where appropriate, for basic cooling and heating of various fluids.

The illustrated embodiment shows an HVAC system for building environmental management that may utilize heat exchangers. A building 10 is cooled by a system that includes a chiller 12 and a boiler 14. As shown, the chiller 12 is disposed on the roof of building 10, and the boiler 14 is located in the basement; however, the chiller 12 and boiler 14 may be located in other equipment rooms or areas next to the building 10. The chiller 12 may be an air cooled or water cooled device that implements a refrigeration cycle to cool water or other conditioning fluid. The chiller 12 is housed within a structure that includes a refrigeration circuit, a free cooling system, and associated equipment such as pumps, valves, and piping. For example, the chiller 12 may be single package rooftop unit that incorporates a free cooling system. The boiler 14 is a closed vessel in which water is heated. The water from the chiller 12 and the boiler 14 is circulated through the building 10 by water conduits 16. The water conduits 16 are routed to air handlers 18 located on individual floors and within sections of the building 10.

The air handlers 18 are coupled to ductwork 20 that is adapted to distribute air between the air handlers 18 and may receive air from an outside intake (not shown). The air handlers 18 include heat exchangers that circulate cold water from the chiller 12 and hot water from the boiler 14 to provide heated or cooled air to conditioned spaces within the building 10. Fans within the air handlers 18 draw air through the heat exchangers and direct the conditioned air to environments within building 10, such as rooms, apartments, or offices, to maintain the environments at a designated temperature. A control device 22, shown here as including a thermostat, may be used to designate the temperature of the conditioned air. The control device 22 also may be used to control the flow of air through and from the air handlers 18. Other devices may be included in the system, such as control valves that regulate the flow of water and pressure and/or temperature transducers or switches that sense the temperatures and pressures of the water, the air, and so forth. Moreover, control devices 22 may include computer systems that are integrated with or separate from other building control or monitoring systems, and even systems that are remote from the building 10.

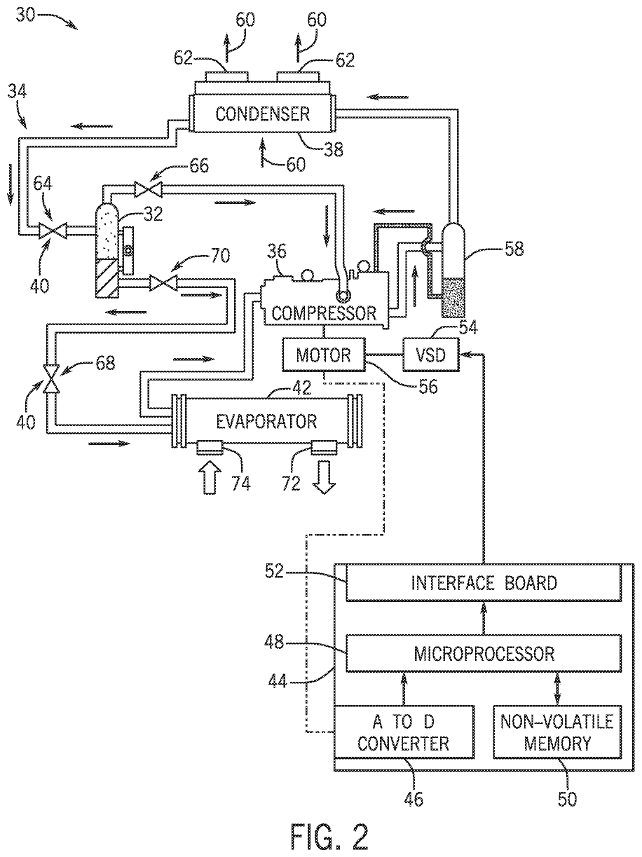

FIG. 2 is a schematic of an embodiment of a vapor compression system or circuit 30 having a flash tank 32 (e.g., economizer tank). For example, the vapor compression system 30 may be a part of an air-cooled chiller. However, it should be appreciated that the disclosed techniques may be incorporated with a variety of other types of chillers. The vapor compression system 30 includes a refrigerant circuit 34 configured to circulate a working fluid, such as refrigerant, therethrough with a compressor 36 (e.g., a screw compressor) disposed along the refrigerant circuit 34. The refrigerant circuit 34 also includes the flash tank 32, a condenser 38, expansion valves or devices 40, and a liquid chiller or an evaporator 42. The components of the refrigerant circuit 34 enable heat transfer between the working fluid and other fluids (e.g., a conditioning fluid, air, water, etc.) in order to provide cooling to an environment, such as an interior of the building 10.

Some examples of working fluids that may be used as refrigerants in the vapor compression system 30 are hydrofluorocarbon (HFC) based refrigerants, for example, R-410A, R-407, R-134a, hydrofluoro-olefin (HFO), “natural” refrigerants like ammonia (NH3), R-717, carbon dioxide (CO2), R-744, or hydrocarbon based refrigerants, water vapor, refrigerants with low global warming potential (GWP), or any other suitable refrigerant. In some embodiments, the vapor compression system 30 may be configured to efficiently utilize refrigerants having a normal boiling point of about 19 degrees Celsius (66 degrees Fahrenheit or less) at one atmosphere of pressure, also referred to as low pressure refrigerants, versus a medium pressure refrigerant, such as R-134a. As used herein, “normal boiling point” may refer to a boiling point temperature measured at one atmosphere of pressure.

The vapor compression system 30 may further include a control panel 44 (e.g., controller) that has an analog to digital (A/D) converter 46, a microprocessor 48, a non-volatile memory 50, and/or an interface board 52. In some embodiments, the vapor compression system 30 may use one or more of a compressor variable speed drive (VSDs) 54 and a compressor motor 56. The compressor motor 56 may drive the compressor 36 and may be powered by the compressor VSD 54. The compressor VSD 54 receives alternating current (AC) power having a particular fixed line voltage and fixed line frequency from an AC power source, and provides power having a variable voltage and frequency to the compressor motor 56. In other embodiments, the compressor motor 56 may be powered directly from an AC or direct current (DC) power source. The compressor motor 56 may include any type of electric motor that can be powered by the compressor VSD 54 or directly from an AC or DC power source, such as a switched reluctance motor, an induction motor, an electronically commutated permanent magnet motor, or another suitable motor.

The compressor 36 compresses a refrigerant vapor and may deliver the vapor to an oil separator 58 that separates oil from the refrigerant vapor. The refrigerant vapor is then directed toward the condenser 38, and the oil is returned to the compressor 36. The refrigerant vapor delivered to the condenser 38 may transfer heat to a cooling fluid at the condenser 38. For example, the cooling fluid may be ambient air 60 forced across heat exchanger coils of the condenser 38 by condenser fans 62. The refrigerant vapor may condense to a refrigerant liquid in the condenser 38 as a result of thermal heat transfer with the cooling fluid (e.g., the ambient air 60).

The liquid refrigerant exits the condenser 38 and then flows through a first expansion device 64 (e.g., expansion device 40, electronic expansion valve, etc.). The first expansion device 64 may be a flash tank feed valve configured to control flow of the liquid refrigerant to the flash tank 32. The first expansion device 64 is also configured to lower the pressure of (e.g., expand) the liquid refrigerant received from the condenser 38. During the expansion process, a portion of the liquid may vaporize, and thus, the flash tank 32 may be used to separate the vapor from the liquid received from the first expansion device 64. Additionally, the flash tank 32 may provide for further expansion of the liquid refrigerant because of a pressure drop experienced by the liquid refrigerant when entering the flash tank 32 (e.g., due to a rapid increase in volume experienced when entering the flash tank 32).

The vapor in the flash tank 32 may exit and flow to the compressor 36. For example, the vapor may be drawn to an intermediate stage or discharge stage of the compressor 36 (e.g., not the suction stage). A valve 66 (e.g., economizer valve, solenoid valve, etc.) may be included in the refrigerant circuit 34 to control flow of the vapor refrigerant from the flash tank 32 to the compressor 36. In some embodiments, when the valve 66 is open (e.g., fully open), additional liquid refrigerant within the flash tank 32 may vaporize and provide additional subcooling of the liquid refrigerant within the flash tank 32. The liquid refrigerant that collects in the flash tank 32 may be at a lower enthalpy than the liquid refrigerant exiting the condenser 38 because of the expansion in the first expansion device 64 and/or the flash tank 32. The liquid refrigerant may flow from the flash tank 32, through a second expansion device 68 (e.g., expansion device 40, an orifice, etc.), and to the evaporator 42. In some embodiments, the refrigerant circuit 34 may also include a valve 70 (e.g., drain valve) configured to regulate flow of liquid refrigerant from the flash tank 32 to the evaporator 42. For example, the valve 70 may be controlled (e.g., via the control panel 44) based on an amount of suction superheat of the refrigerant.

The liquid refrigerant delivered to the evaporator 42 may absorb heat from a conditioning fluid, which may or may not be the same cooling fluid used in the condenser 38. The liquid refrigerant in the evaporator 42 may undergo a phase change to become vapor refrigerant. For example, the evaporator 42 may include a tube bundle fluidly coupled to a supply line 72 and a return line 74 that are connected to a cooling load. The conditioning fluid of the evaporator 42 (e.g., water, oil, calcium chloride brine, sodium chloride brine, or any other suitable fluid) enters the evaporator 42 via the return line 74 and exits the evaporator 42 the via supply line 72. The evaporator 42 may reduce the temperature of the conditioning fluid in the tube bundle via thermal heat transfer with the refrigerant so that the conditioning fluid may be utilized to provide cooling for a conditioned environment. The tube bundle in the evaporator 42 can include a plurality of tubes and/or a plurality of tube bundles. In any case, the refrigerant vapor exits the evaporator 42 and returns to the compressor 36 by a suction line to complete the refrigerant cycle.

In some circumstances, an HVAC system may have a single electrical enclosure configured to house multiple components, such as electrical subsystems (e.g., to block exposure of certain electrical components to an ambient environment). In some embodiments, a first electrical subsystem configured to operate the compressor of the HVAC system and a second electrical subsystem configured to operate the condenser of the HVAC system may be disposed within the electrical enclosure. Furthermore, a cooling system may be disposed within the electrical enclosure to cool both the first electrical subsystem and the second electrical subsystem, thereby improving operation of electrical subsystems and of the HVAC system. Disposing both electrical subsystems in a shared electrical enclosure may improve manufacture and/or operation of the HVAC system, such as by reducing cost and/or complexity associated with implementation of other components to enable operation of the electrical subsystems, by reducing an energy consumption associated with operation of the HVAC system, and/or by reducing a footprint occupied by the HVAC system (e.g., occupied by the electrical enclosure and the electrical subsystems disposed therein).

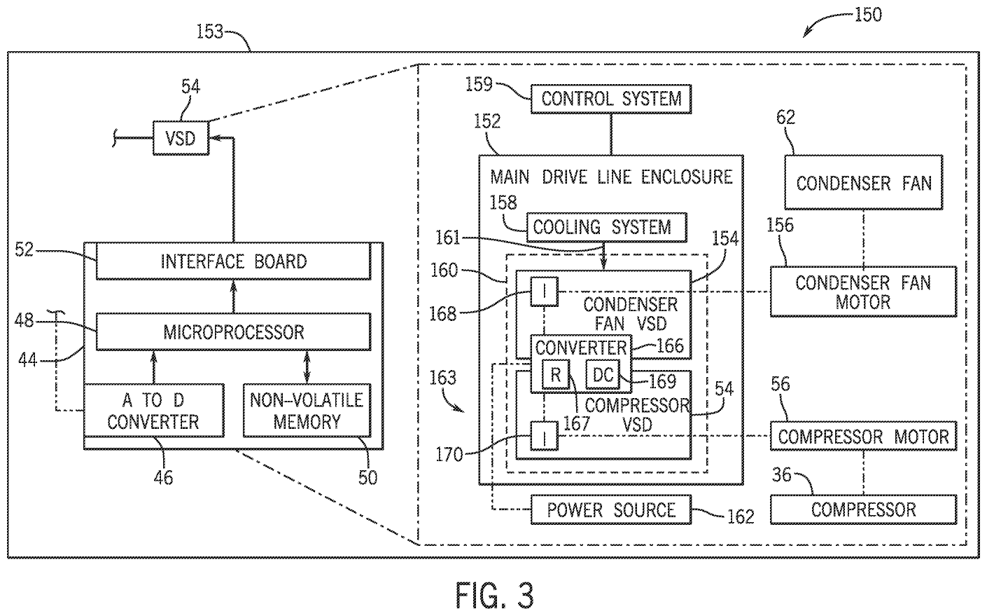

With the preceding in mind, FIG. 3 is a schematic of an embodiment of an HVAC system 150 (e.g., a chiller system) having a main drive line enclosure 152 (e.g., a main drive line electrical enclosure). As described herein, the main drive line enclosure 152 is configured to house one or more electrical subsystems of the HVAC system 150. For instance, the HVAC system 150 may have a main housing or support structure 153. The main housing 153 may be configured to enclose or support multiple components of the vapor compression system 30. As an example, the main housing 153 may enclose and/or support the compressor 36, the condenser 38, the evaporator 42, and so forth. The main housing 153 may also enclose or support multiple enclosures, including the main drive line enclosure 152. For example, the main drive line enclosure 152 may be attached or secured to the main housing 153, enclosed by the main housing 153, or otherwise associated with the main housing 153. The main drive line enclosure 152 may enclose a set of components (e.g., electrical components) that specifically functions to receive, convert, distribute, and so forth electrical power in order to drive operation of other components of the HVAC system 150. Although the illustrated HVAC system 150 may be an air-cooled chiller system in which the main drive line enclosure 152 may house various components of the vapor compression system 30, the main drive line enclosure 152 may be implemented in any suitable HVAC system 150, such as a liquid-cooled chiller system, a direct expansion HVAC system, and so forth, to enclose any suitable components (e.g., electrical components) of the HVAC system 150.

The main drive line enclosure 152 is configured to house the compressor VSD 54. The compressor VSD 54 may be electrically coupled to the compressor motor 56 and may be configured to operate the compressor motor 56 and drive the compressor 36 to pressurize the refrigerant flowing through the vapor compression system 30. For instance, the compressor VSD 54 may operate the compressor motor 56 to drive the compressor 36 (e.g., at a variable speed) in accordance with a particular operating parameter (e.g., a capacity, a frequency), thereby controlling a pressurization of the refrigerant (e.g., based on a target pressurization of the refrigerant). The main drive line enclosure 152 may also be configured to house a condenser fan VSD 154, which may be electrically coupled to a condenser fan motor 156. The condenser fan motor 156 may drive operation of the condenser fan 62 of the HVAC system 150. For instance, the condenser fan VSD 154 may control operation of the condenser fan motor 156 to variably drive rotation of the condenser fan 62 in order to direct an air flow across the condenser 38 and cool the refrigerant flowing through the condenser 38. Indeed, the condenser fan VSD 154 may control the flow rate of the air directed by the condenser fan 62 (e.g., based on a target flow rate of the air, a target refrigerant temperature or pressure, etc.), thereby controlling the cooling provided to the refrigerant by condenser fan 62.

Such arrangement of both the compressor VSD 54 and the condenser fan VSD 154 within the main drive line enclosure 152 may enable more efficient use of space within or occupied by the HVAC system 150. For instance, by using a single main drive line enclosure 152 to house both the compressor VSD 54 and the condenser fan VSD 154, the HVAC system 150 may include fewer enclosures (e.g., electrical enclosures) that would otherwise have a separate, respective footprint and contain separate components. Thus, the main drive line enclosure 152 obviates the inclusion or implementation of an additional enclosure, thereby reducing an overall or cumulative size or footprint of enclosures in the HVAC system 150. As a result, overall costs of manufacturing and/or space occupied by the HVAC system 150 and/or the components disposed therein may be reduced, and/or additional space may be available for additional components to be implemented to (e.g., installed within) the HVAC system 150 in place of the additional enclosure.

The main drive line enclosure 152 may further include a cooling system 158 configured to provide cooling for the compressor VSD 54 and/or for the condenser fan VSD 154 in order to avoid overheating of the compressor VSD 54 and/or the condenser fan VSD 154 and to improve operation of the compressor VSD 54 and/or the condenser fan VSD 154. To this end, the cooling system 158 may place the compressor VSD 54 and/or the condenser fan VSD 154 in a heat exchange relationship with a cooling fluid configured to absorb heat from and cool the compressor VSD 54 and/or the condenser fan VSD 154. By way of example, the cooling system 158 may include a fan configured to draw or force air (e.g., ambient air) across the compressor VSD 54 and/or the condenser fan VSD 154 for convection cooling. Additionally or alternatively, the cooling system 158 may direct a cooled liquid (e.g., water, glycol) to absorb heat from the compressor VSD 54 and/or the condenser fan VSD 154. In any case, a single embodiment of the cooling system 158 may be used to cool both the compressor VSD 54 and/or the condenser fan VSD 154. In other words, each of the compressor VSD 54 and the condenser fan VSD 154 may be cooled by the cooling system 158 (e.g., a common or shared cooling system), thereby reducing cost, complexity, and/or energy consumption as compared to an HVAC system having multiple enclosures that separately house the compressor VSD 54 and the condenser fan VSD 154 and that include a separate cooling system for cooling the respective component(s) therein. However, in alternative embodiments, multiple cooling systems 158 may be implemented within the main drive line enclosure 152 to provide increased cooling of the compressor VSD 54 and/or the condenser fan VSD 154. Indeed, each of a plurality of cooling systems 158 disposed within the main drive line enclosure 152 may provide cooling for both the compressor VSD 54 and the condenser fan VSD 154.

Additionally, in the illustrated embodiment, the compressor 36, the compressor motor 56, the condenser fan 62 (e.g., the condenser 38 and the condenser fan 62), and the condenser fan motor 156 are positioned external to the main drive line enclosure 152 and within the main housing 153, the condenser fan VSD 154 is electrically (e.g., communicatively) coupled to the condenser fan motor 156, and the compressor VSD 54 is electrically (e.g., communicatively) coupled to the compressor motor 56. The main drive line enclosure 152 may be sized to accommodate the compressor VSD 54, the condenser fan VSD 154, and/or the cooling system 158 without being sized to house components such as the compressor 36, the compressor motor 56, the condenser fan 62, and/or the condenser fan motor 156. As such, the main drive line enclosure 152 may be more efficiently implemented within the main housing 153 of the HVAC system 150, thereby limiting a cost associated with manufacture of the main drive line enclosure 152 and/or a footprint occupied by the main drive line enclosure 152. However, in other embodiments, the size of the main drive line enclosure 152 may be increased in order to position additional components (e.g., additional electrical components configured to enable operation of the compressor VSD 54 and/or condenser fan VSD 154) in the main drive line enclosure 152 along with the compressor VSD 54, the condenser fan VSD 154, and/or the cooling system 158. For example, the main drive line enclosure 152 may include additional power electronics, converters, inverters, and so forth disposed therein. In such embodiments, the cooling system 158 may also be positioned, manufactured, or otherwise arranged to provide additional cooling to any additional components disposed within the main drive line enclosure 152.

In certain embodiments, a control system 159 (e.g., the control panel 44, a controller) may be disposed within, coupled to, or otherwise associated with the main drive line enclosure 152. The control system 159 may be communicatively coupled to the condenser fan VSD 154 and/or the compressor VSD 54. In some embodiments, the control system 159 may include the control panel 44 discussed above. For example, a user (e.g., an operator, a technician, a resident) may utilize the control system 159, such as a user interface of the control system 159, to control operation of various components of the HVAC system 150. Thus, the control system 159 may include one or more features (e.g., a touchscreen, a button, a switch, a dial, trackpad) with which the user may interact, and the control system 159 may output a control signal based on the interaction between the user and the control system 159 to operate the HVAC system 150. That is, the control system 159 may receive a user input, and the control system 159 may transmit the control signal to other equipment or components of the HVAC system 150, such as components within the main drive line enclosure 152 (e.g., the condenser fan VSD 154, the compressor VSD 54), based on the user input. As an example, the user input may be indicative of a target operating parameter of the HVAC system 150, such as a pressure or temperature of the refrigerant discharged by the compressor 36 and/or a target flow rate of air to be directed across the condenser 38 by the condenser fan 62, and the control signal output by the control system 159 may cause the compressor VSD 54 and/or the condenser fan VSD 154 to drive operation of the compressor motor 56 and/or the condenser fan motor 156, respectively, based on the user input.

For this reason, the control system 159 may be arranged with the HVAC system 150 (e.g., relative to the main drive line enclosure 152) in a manner to facilitate user access. By way of example, the control system 159 may be positioned adjacent, at, or on an exterior surface of the main drive line enclosure 152, the main drive line enclosure 152 may include a movable component (e.g., a door, a cover, an access panel) that may be transitioned to expose the control system 159 to the user, and/or the control system 159 and/or the main drive line enclosure 152 may be arranged in another suitable manner to facilitate user access of the control system 159.

In some embodiments, the compressor VSD 54 and the condenser fan VSD 154 may be arranged or positioned proximate to one another, such as in a section 160 (e.g., a common section, a shared volume, a sub-enclosure) within the main drive line enclosure 152. Such arrangement of the compressor VSD 54 and the condenser fan VSD 154 may facilitate the manufacture or a more efficient configuration of the main drive line enclosure 152. As an example, the cooling system 158 may be positioned or oriented to direct a cooling fluid 161 toward the single section 160, instead of toward multiple sections within the main drive line enclosure 152 in order to provide more efficient cooling of both the compressor VSD 54 and the condenser fan VSD 154. Therefore, the section 160 may reduce a complexity associated with manufacture, implementation, and/or operation of the cooling system 158 to cool both the compressor VSD 54 and the condenser fan VSD 154. For example, arrangement of the compressor VSD 54 and the condenser fan VSD 154 within the section 160 may enable more efficient operation of the cooling system 158.

Additionally, in certain embodiments, both the compressor VSD 54 and the condenser fan VSD 154 may receive power from a power source or supply 162, such as a power grid, a battery, a solar panel, an electrical generator, a gas engine, another suitable power source that provides electrical power, or any combination thereof. That is, the power source 162 may provide electrical power that is used by both the compressor VSD 54 and the condenser fan VSD 154 to operate the compressor motor 56 and the condenser fan motor 156, respectively. Arrangement of the compressor VSD 54 and the condenser fan VSD 154 within the section 160 may simplify electrical coupling of the power source 162 to the compressor VSD 54 and the condenser fan VSD 154, such as by limiting a quantity, length, or complexity of wiring or other power circuitry 163 electrically coupling the power source 162 to the compressor VSD 54 and the condenser fan VSD 154 for power transmission. Indeed, the power circuitry 163 may be routed from the power source 162 toward the single section 160 instead of toward multiple sections within the main drive line enclosure 152 in order to electrically couple the power source 162 to the compressor VSD 54, the condenser fan VSD 154, or both. Although the illustrated power source 162 is external to the main drive line enclosure 152, an additional or alternative embodiment of the power source 162 may be at least partially located within the main drive line enclosure 152. Moreover, the power source 162 may be configured to provide electrical power to any additional component of the HVAC system 150, such as to the cooling system 158, to the control system 159, to another suitable component, or any combination thereof.

Further still, the main drive line enclosure 152 and/or the section 160 may facilitate access by the user, such as for maintenance of the HVAC system 150. In some embodiments, the main drive line enclosure 152 and/or the section 160 may enable concurrent access to both the compressor VSD 54 and the condenser fan VSD 154. As such, the user may navigate or access a single section or enclosure, instead of multiple sections or enclosure, to access the compressor VSD 54 and the condenser fan VSD 154. For example, the compressor VSD 54 and the condenser fan VSD 154 may be arranged within the section 160 and/or the main drive line enclosure 152 in a manner that enables the user to concurrently view, move, replace, remove, and/or perform any suitable action associated with the compressor VSD 54 and/or the condenser fan VSD 154. Such arrangement of the compressor VSD 54 and/or the condenser fan VSD 154 may facilitate improved (e.g., more efficient) performance of various tasks (e.g., maintenance) associated with the HVAC system 150.

In some embodiments, a converter section 166 (e.g., a converter, a common converter section, a shared converter section) may be disposed within the main drive line enclosure 152. The compressor VSD 54 and the condenser fan VSD 154 may each operate with or include the converter section 166, and the converter section 166 may include components, such as a rectifier 167, a DC link 169, or another suitable component, configured to receive electrical power from the power source 162, condition or adjust the electrical power, and supply the electrical power to the compressor VSD 54 and to the condenser fan VSD 154. However, each of the compressor VSD 54 and the condenser fan VSD 154 may have a separate inverter section (e.g., an individual and/or dedicated inverter section that is not shared between the compressor VSD 54 and the condenser fan VSD 154). For example, the condenser fan VSD 154 may include a condenser fan inverter section 168 (e.g., an inverter, a first inverter) configured to receive electrical power (e.g., conditioned electrical power) from the converter section 166, condition or adjust the received electrical power, and supply the electrical power (e.g., via the condenser fan VSD 154) to the condenser fan motor 156 for operating the condenser fan 62. The compressor VSD 54 may similarly include a compressor inverter section 170 (e.g., an inverter, a second inverter) configured to receive electrical power (e.g., conditioned electrical power separate from the conditioned electrical power received by the condenser fan inverter section 168) from the converter section 166, condition or adjust the received electrical power, and supply the electrical power (e.g., via the compressor VSD 54) to the compressor motor 56 for operating the compressor 36.

The rectifier 167 and/or the DC link 169 may be configured to supply adjusted electrical power (e.g., respective adjusted electrical power) to both the condenser fan inverter section 168 and the compressor inverter section 170 (e.g., in a parallel flow). In this way, the electrical coupling between the power source 162, the compressor VSD 54, and the condenser fan VSD 154 may be further simplified. That is, the power circuitry 163 may extend from the power source 162 to a single converter section 166 (e.g., within the section 160 of the main drive line enclosure 152) instead of to multiple converter sections 166. In some embodiments, the converter section 166 (e.g., the rectifier 167, the DC link 169) may be a component of (e.g., an existing component electrically coupled to, an existing component integrated with) the compressor VSD 54. Thus, the condenser fan VSD 154 may not include a separate converter section (e.g., a converter section that receives electrical power, such as from the power source 162, separately from the electrical power received by the converter section 166 of the compressor VSD 54 and that is dedicated to supplying electrical power to the condenser fan VSD 154).

Although the illustrated main drive line enclosure 152 includes the compressor VSD 54 and the condenser fan VSD 154, the main drive line enclosure 152 may include additional or alternative components configured to enable operation of the compressor motor 56 and/or the condenser fan motor 156. For instance, the main drive line enclosure 152 may include a switch, a filter, a fuse, a relay, another suitable component, or any combination thereof that may, for example, facilitate power distribution or supply from the power source 162 to the components of the HVAC system 150, increase a longevity of components of the HVAC system 150 (e.g., by blocking an undesirable amount of electrical power from being supplied to HVAC system 150 components), or otherwise improve operation of the compressor VSD 54 and/or the condenser fan VSD 154. The main drive line enclosure 152 may further include other subsystems, such as an additional electrical subsystem to operate a motor for a pump, another fan, another suitable component, or any combination thereof, of the HVAC system 150.

The present disclosure may provide one or more technical effects useful for an HVAC system. For example, the HVAC system may include a single electrical enclosure configured to house multiple electrical components. In some embodiments, the electrical enclosure may house a condenser fan VSD configured to control operation of a condenser fan motor, which may drive operation of a condenser fan of the HVAC system. The electrical enclosure may also house a compressor VSD configured to control operation of a compressor motor, which may drive operation of a compressor of the HVAC system. The electrical enclosure may further house a cooling system configured to cool the condenser fan VSD and the compressor VSD and therefore improve operation of the condenser fan VSD and the compressor VSD. In certain embodiments, the electrical enclosure may include a converter section configured to direct electrical power to both the condenser fan VSD and the compressor VSD (e.g., to respective inverters of the condenser fan VSD and the compressor VSD). The electrical enclosure may improve a manufacture and/or operation of the HVAC system. For instance, disposing the condenser fan VSD, the compressor VSD, the cooling system, and the converter section in a single electrical enclosure may reduce a cost or complexity associated with manufacture of multiple electrical enclosures (e.g., configured to separately house the condenser fan VSD and the compressor VSD), a total footprint occupied by multiple electrical enclosures, and/or an energy consumption associated with operating multiple cooling systems (e.g., configured to separately cool the condenser fan VSD and the compressor VSD). The technical effects and technical problems in the specification are examples and are not limiting. It should be noted that the embodiments described in the specification may have other technical effects and can solve other technical problems.

While only certain features of present embodiments have been illustrated and described herein, many modifications and changes will occur to those skilled in the art. It is, therefore, to be understood that the appended claims are intended to cover all such modifications and changes that fall within the true spirit of the disclosure. Further, it should be understood that certain elements of the disclosed embodiments may be combined or exchanged with one another.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A heating, ventilation, and/or air conditioning (HVAC) system, comprising:
an electrical enclosure comprising a compressor variable speed drive (VSD) and a condenser fan VSD disposed within the electrical enclosure, wherein the compressor VSD is configured to control operation of a compressor motor of the HVAC system, and the condenser fan VSD is configured to control operation of a condenser fan motor of the HVAC system.

2. The HVAC system of claim 1, comprising the compressor motor, wherein the compressor motor is electrically coupled to a compressor of the HVAC system, and the compressor VSD is configured to control operation of the compressor motor to operate the compressor.

3. The HVAC system of claim 1, comprising the condenser fan motor, wherein the condenser fan motor is electrically coupled to a condenser fan of the HVAC system, and the condenser fan VSD is configured to control operation of the condenser fan motor to operate the condenser fan.

4. The HVAC system of claim 1, wherein the electrical enclosure comprises a cooling system disposed therein, and the cooling system is configured to provide cooling to the compressor VSD and the condenser fan VSD.

5. The HVAC system of claim 4, wherein the cooling system is configured to place a cooling fluid in a heat exchange relationship with the compressor VSD and the condenser fan VSD to absorb heat from and cool the compressor VSD and the condenser fan VSD.

6. The HVAC system of claim 1, wherein the compressor VSD and the condenser fan VSD are disposed within a common section of the electrical enclosure.

7. The HVAC system of claim 1, comprising a control system coupled to the electrical enclosure, wherein the control system is configured to:
output a control signal to operate the compressor VSD, the condenser fan VSD, or both;
receive a user input; and
output the control signal based on the user input.

8. The HVAC system of claim 1, comprising a converter section disposed within the electrical enclosure, wherein the converter section comprises a rectifier and a direct current (DC) link, and the converter section is configured to direct power to the compressor VSD and the condenser fan VSD.

9. The HVAC system of claim 8, wherein the compressor VSD comprises a first inverter section configured to receive first power from the converter section, and the condenser fan VSD comprises a second inverter section configured to receive second power from the converter section.

10. A heating, ventilation, and/or air conditioning (HVAC) system, comprising:
an electrical enclosure configured to enclose electrical components of the HVAC system to shield the electrical components from an ambient environment;
a compressor variable speed drive (VSD) disposed within the electrical enclosure, wherein the compressor VSD is configured to operate a compressor motor of the HVAC system;
a condenser fan VSD disposed within the electrical enclosure, wherein the condenser fan VSD is configured to operate a condenser fan motor of the HVAC system; and
a cooling system disposed within the electrical enclosure, wherein the cooling system is configured to place a cooling fluid in a heat exchange relationship with the compressor VSD and the condenser fan VSD and to reject heat from the compressor VSD and the condenser fan VSD.

11. The HVAC system of claim 10, wherein the compressor VSD is configured to operate the compressor motor to drive operation of a compressor of the HVAC system, and the condenser fan VSD is configured to operate the condenser fan motor to drive operation of a condenser fan of the HVAC system.

12. The HVAC system of claim 10, comprising the compressor motor and the condenser fan motor, wherein the compressor motor and the condenser fan motor are positioned external to the electrical enclosure.

13. The HVAC system of claim 10, comprising:
a converter disposed within the electrical enclosure;
a first inverter of the compressor VSD; and
a second inverter of the condenser fan VSD,
wherein the first inverter and the second inverter are each electrically coupled to the converter and are configured to receive power from the converter.

14. The HVAC system of claim 13, wherein the converter is a component of the compressor VSD.

15. The HVAC system of claim 10, comprising power circuitry configured to electrically couple a power source to the compressor VSD and to the condenser fan VSD, wherein the power circuitry extends from the power source to the electrical enclosure.

16. A heating, ventilation, and/or air conditioning (HVAC) system, comprising:
a refrigerant circuit;
a compressor disposed along the refrigerant circuit and configured to pressurize a refrigerant flowing through the refrigerant circuit;
a condenser disposed along the refrigerant circuit, wherein the condenser comprises a condenser fan configured to force an air flow across the condenser to cool the refrigerant flowing through the refrigerant circuit;
a main drive line electrical enclosure, wherein the compressor and the condenser are positioned external to the main drive line electrical enclosure;
a compressor variable speed drive (VSD) disposed within the main drive line electrical enclosure, wherein the compressor VSD is configured to operate a compressor motor to drive operation of the compressor to pressurize the refrigerant; and
a condenser fan VSD disposed within the main drive line electrical enclosure, wherein the condenser fan VSD is configured to operate a condenser fan motor to drive operation of the condenser fan to force the air flow across the condenser.

17. The HVAC system of claim 16, wherein the compressor VSD comprises a converter section that comprises a rectifier and a direct current (DC) link.

18. The HVAC system of claim 17, wherein the converter section is configured to receive electrical power from a power supply, the compressor VSD comprises a first inverter section, the condenser fan VSD comprises a second inverter section, and the converter section is configured to supply the electrical power to both the first inverter section and the second inverter section.

19. The HVAC system of claim 16, comprising a control system communicatively coupled to the compressor VSD and to the condenser fan VSD, wherein the control system is configured to receive a user input indicative of a target operating parameter of the HVAC system and configured to output a control signal to operate the compressor VSD, the condenser fan VSD, or both, based on the user input.

20. The HVAC system of claim 19, wherein the control system is disposed external to the main drive line electrical enclosure.
